(19) United States
(12) Patent Application Publication
(10) Pub. No.: US 2008/0136820 A1
(43) Pub. Date: Jun. 12, 2008

(54) Progressive cut: interactive object segmentation

(75) Inventors: Qiong Yang, Beijing (CN); Chao Wang, Hefei (CN); Mo Chen, Beijing (CN); Xiaoou Tang, Beijing (CN); Zhongfu Ye, Hefei (CN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/897,224

(22) Filed: Aug. 29, 2007

Related U.S. Application Data
(60) Provisional application No. 60/853,063, filed on Oct. 20, 2006.

(51) Int. Cl. G06T 11/20; G06F 3/041

(52) U.S. Cl. 345/440; 345/173; 382/173

(57) ABSTRACT

Progressive cut interactive object segmentation is described. In one implementation, a system analyzes strokes input by the user during iterative image segmentation in order to model the user's intention for refining segmentation. In the user intention model, the color of each stroke indicates the user's expectation of pixel label change to foreground or background, the location of the stroke indicates the user's region of interest, and the position of the stroke relative to a previous segmentation boundary indicates a segmentation error that the user intends to refine. Overexpansion of pixel label change is controlled by penalizing change outside the user's region of interest while overshrinkage is controlled by modeling the image as an eroded graph. In each iteration, energy consisting of a color term, a contrast term, and a user intention term is minimized to obtain a segmentation map.

### RELATED APPLICATIONS

This application claims priority to U.S. Provisional Patent Application No. 60/853,063 entitled, “Progressive Cut Interactive Image Segmentation,” to Yang et al., filed Oct. 20, 2006 and incorporated herein by reference.

### BACKGROUND

Object cutout is a technique for cutting a visual foreground object from the background of an image. Currently, no image analysis technique can be applied fully automatically to guarantee cutout results over a broad class of image sources, content, and complexity. So, semi-automatic segmentation techniques that rely on user interaction are becoming increasingly popular.

Currently, there are two types of interactive object cutout methods: boundary-driven methods and seed-driven methods. The boundary-driven methods often use user-interaction tools such as brush or lasso. Such tools drive the user's attention to the boundary of the visual foreground object in the image. These generally allow the user to trace the object's boundary. However, a high number of user interactions are often necessary to obtain a satisfactory result by using a lasso for highly textured (or even un-textured) regions, and a considerable degree of user interaction is required to get a high quality matte using brushes. Such boundary-driven methods require much of the user's attention, especially when the boundary is complex or has long curves. Thus, these methods are not ideal for the initial part of the cutout task.

The seed-driven methods require the user to input some example points, strokes, or regions of the image as seeds, and then use these to label the remaining pixels automatically. A given seed-driven method starts with a user-specified point, stroke, or region and then computes connected pixels such that all pixels to be connected fall within some adjustable tolerance of the color characteristics of the specified region.

As shown in FIG. 1, however, a general problem of the stroke-based graph-cut methods is that for most images, the use of only two strokes 100 and 102 (e.g., to designate foreground object 100 and background 102) is not sufficient to achieve a good result because large erroneous segmentation errors 104 occur. Additional refinement using more strokes is needed. With additional strokes, the user iteratively refines the result until the user is satisfied.

Most conventional stoke-based graph-cut methods use only color information of the image when using each additional stroke to update the graph cut model, and then the entire image is re-segmented based on the updated graph cut model. This type of solution is simple, but the technique may bring an unexpected label change in which of part of the foreground changes into background, or vice versa, which causes an unsatisfactory “fluctuation” effect during the user experience. In FIG. 1, the extra stroke 106 results in correction of segmentation for one pant leg of the depicted man while the other pant leg 108 incorrectly changes its label from foreground to background.

Likewise, FIG. 2(a) is a segmentation result from an initial two strokes 202 and 204. When an additional corrective background stroke 206 (green arrow in color version of the Figure) is added behind the neck of the man, the region behind his trousers 208 is turned into foreground—that is, the background overshrinks in an unexpected location 208 (see the red circle in FIG. 2(b)). Such a change of label is unexpected.

FIG. 2(c) is an initial two stroke segmentation result containing segmentation errors. The additional stroke 210 (see green arrow) in the upper right corner performs a segmentation correction but also unexpectedly shrinks the dog's back in a nearby location 212—that is, the additional stroke 210 overexpands the background in the location 212 as shown in FIG. 2(d). These unexpected side effects (e.g., 206 and 212) stem from adding an additional stroke that corrects a segmentation error in an initial location. The unexpected side effects result in an unpleasant and frustrating user experience. Further, it causes confusion as to why this effect occurs and what stroke the user should select next.

As shown in FIGS. 2(e) and 2(f), such undesirable label-change effects (206, 212) originate from inappropriate update strategies, which treat the initial and additional strokes as a collection of strokes on equal footing to update the color model in play, rather than as a process that logically unfolds stroke by stroke. In such a conventional scenario, if we consider only the color distribution of the foreground and the color distribution of the background, and ignore the contrast term for simplicity, the graph cut technique can be deemed as a pixel-by-pixel decision based on the color distribution. Pixels are classified as foreground (F) or background (B) according to probability. For example, initial color distributions of foreground 214 (red curve) and background 216 (blue curve) are shown in FIG. 2(e). When an additional background stroke is added, the updated color model of background 218 is shown in FIG. 2(f). Background shrinkage 220 occurs when the original background curve 216 (blue line) draws away from the foreground curve 214 (red curve), which is shown in FIG. 2(f) with respect to curve 218. Background expansion 222 occurs when a new peak of the blue curve 218 overlaps the foreground model 214, as depicted in FIG. 2(d). When this expansion or shrinkage is beyond the user's expectation, it causes an unpleasant user experience.

What is needed is a stroke-based graph-cut method that enhances the user experience by preventing unexpected segmentation fluctuations when the user adds additional strokes to refine segmentation.

### SUMMARY

Progressive cut interactive image segmentation is described. In one implementation, a system analyzes strokes input by the user during iterative image segmentation in order to model the user's intention for refining segmentation. In the user intention model, the color of each stroke indicates the user's expectation of pixel label change to foreground or background, the location of the stroke indicates the user's region of interest, and the position of the stroke relative to a previous segmentation boundary indicates a segmentation error that the user intends to refine. Overexpansion of pixel label change is controlled by penalizing change outside the user's region of interest while overshrinkage is controlled by modeling the image as an eroded graph. In each iteration, energy consisting of a color term, a contrast term, and a user intention term is minimized to obtain a segmentation map.

This summary is provided to introduce exemplary progressive cut interactive image segmentation, which is further described below in the Detailed Description. This summary is not intended to identify essential features of the claimed subject matter, nor is it intended for use in determining the scope of the claimed subject matter.

### BRIEF DESCRIPTION OF THE DRAWINGS

This patent application contains drawings executed in color. Specifically, FIGS. 1-4, 7-11, and 13 are available in color. Copies of this patent application with color drawings will be provided by the Patent Office upon request and payment of the necessary fee.

FIG. 1 is a diagram of conventional stroke-based object cutout.

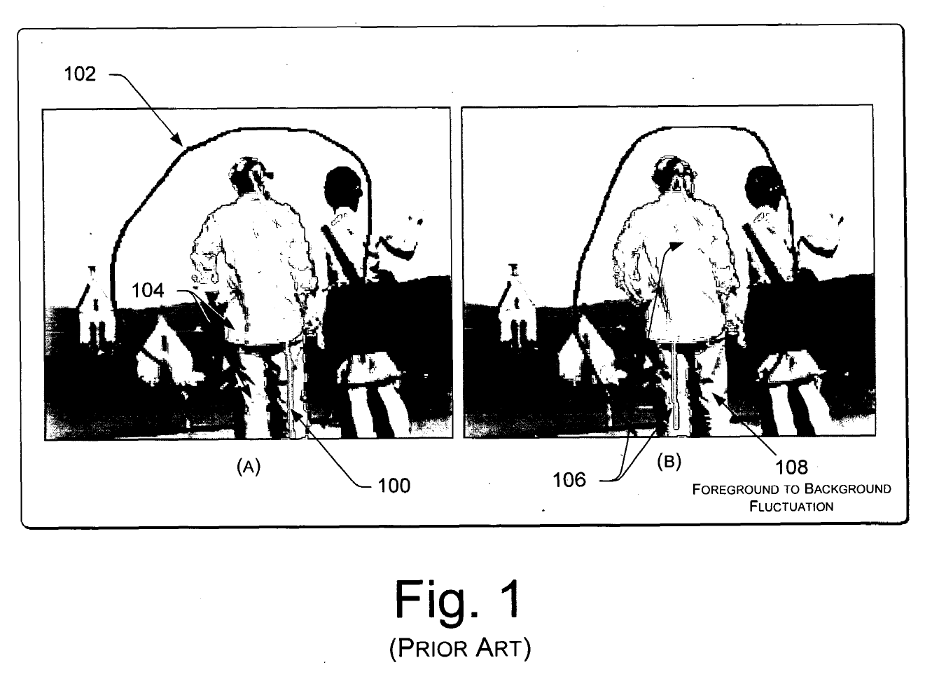

FIG. 2 is a diagram of conventional fluctuation effects during conventional stroke-based object cutout.

FIG. 3 is a diagram of image regions during exemplary stroke-based object cutout.

FIG. 4 is a diagram of an exemplary progressive cutout system.

FIG. 5 is a block diagram of an exemplary progressive cutout engine.

FIG. 6 is a block diagram of exemplary user intention analysis.

FIG. 7 is a diagram of exemplary additional strokes during progressive object cutout.

FIG. 8 is a diagram of an exemplary eroded graph.

FIG. 9 is a diagram of exemplary user attention energy during progressive object cutout.

FIG. 10 is a diagram of an exemplary region of user interest.

FIG. 11 is a diagram of segmentation boundary refinement using polygon adjustment and brush techniques.

FIG. 12 is a flow diagram of an exemplary method of progressive object cutout.

FIG. 13 is a diagram comparing results of conventional graph cut with results of exemplary progressive object cutout.

### DETAILED DESCRIPTION

### Overview

Described herein are systems and methods for performing progressive interactive object segmentation. In one implementation, an exemplary system analyzes a user's intention behind each additional stroke that the user specifies for improving segmentation results, and incorporates the user's intention into a graph-cut framework. For example, in one implementation the color of the stroke indicates the kind of change the user expects; the location of the stroke indicates the user's region of interest; and the relative position between the stroke and the previous segmentation result points to the part of the current segmentation result that has error and needs to be improved.

Most conventional stroke-based interactive object cutout techniques do not consider the user's intention in the user interaction process. Rather, strokes in sequential steps are treated as a collection rather than as a process, and typically only the color information of each additional stroke is used to update the color model in the conventional graph cut framework. In the exemplary system, by modeling the user's intention and incorporating such information into the cutout system, the exemplary system removes unexpected fluctuation inherent in many conventional stroke-based graph-cut methods, and thus provides the user more accuracy and control with fewer strokes and faster visual feedback.

Additionally, in one implementation, an eroded graph of the image is employed to prevent unexpected overshrinkage of the background during segmentation boundary refinement, and a user-attention term is added to the energy function to prevent overexpansion of the background in areas of low interest during segmentation boundary refinement.

Exemplary System

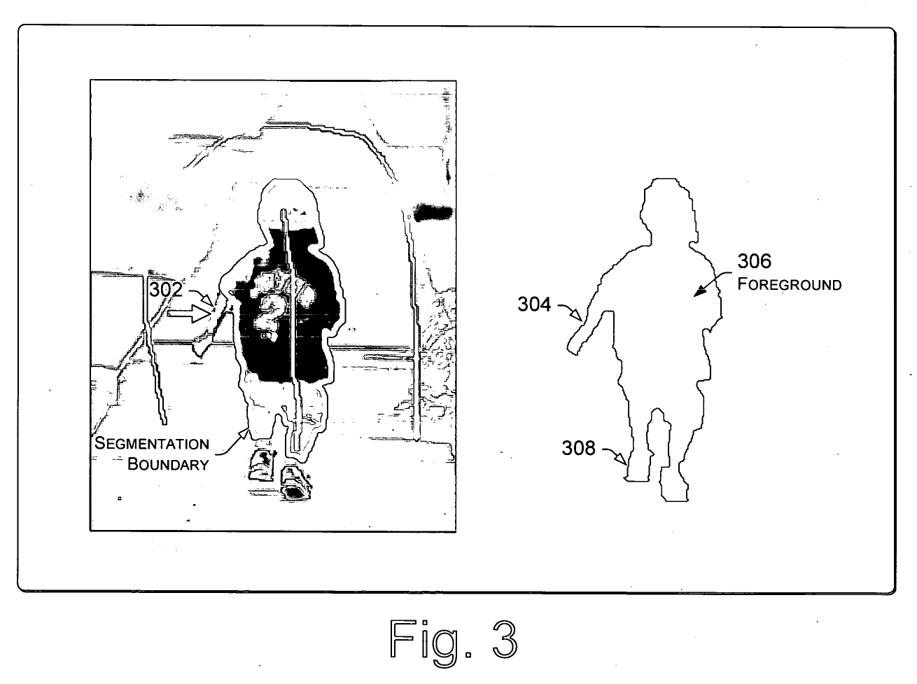

In an exemplary progressive cut system, the user's intention is inferred from the user's interactions, such as an additional stroke, and the intention can be extracted by studying the characteristics of the user interaction. As shown in FIG. 3, the additional stroke 302 indicates several aspects of the user's intention. For example, the additional stroke 302 falls in an erroneous area 304 that the user is inclined to change. The erroneous area 304 is erroneous because the previous segmentation process labeled the erroneous area 304 incorrectly as background instead of foreground. Next, the color of the stroke, representing the intended segmentation label, indicates the kind of change the user expects. For example, a yellow stoke (foreground label) in the background indicates that the user would like to change part of the background into foreground. For those regions that already have the same label as the additional stroke 302 (such as the green region 306—it is already foreground) the user does not expect such regions to change labels during the current progressive cut iteration. Further, the location of the stroke relative to the current segmentation boundary indicates a region of interest for the user, with high interest around the stroke (such as the erroneous red region 304), and low interest in other erroneous areas (such as the pink region 308 of the feet in FIG. 3).

The above analysis of user intention associated with an additional stroke 302 is one way of interpreting user intention during a progressive cut technique. Other ways of deriving user intention from the user's interactions can also be used in an exemplary progressive cut system. There are some common inferences when associating user intention with a user's interactions. For example, a user evaluation process occurs before the user inputs the additional stroke 302, i.e., the user evaluates the previous segmentation result before inputting the additional stroke 302. Then, additional strokes are not uniformly spatially distributed on the whole image, but mostly concentrated in areas evaluated by the user as erroneous.

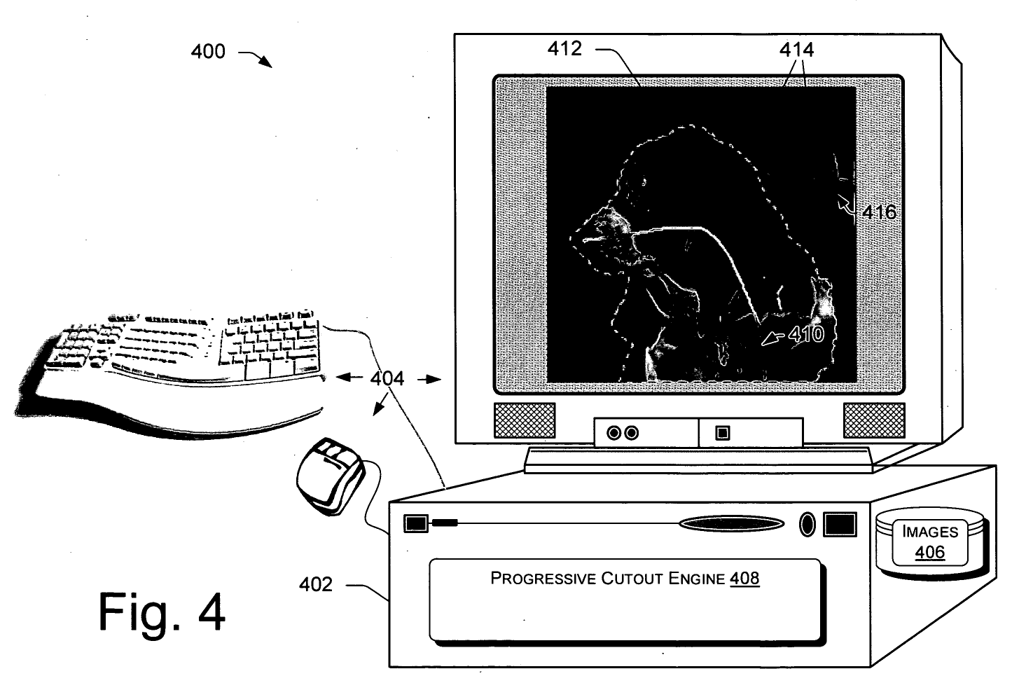

FIG. 4 shows an exemplary progressive cut system 400. A computing device 402 is connected to user interface devices 404, such as keyboard, mouse, and display. The computing device 402 can be a desktop or notebook computer, or other device with processor, memory, data storage, etc. The data storage may store images 406 that include visual foreground objects and background. The computing device 402 hosts an exemplary progressive cutout engine 408 for optimizing stroke-based object cutout.

In a typical cutout session, the user makes an initial foreground stroke 410 to indicate the foreground object and a background stroke 412 to indicate the background. The progressive cutout engine 408 proposes an initial segmentation boundary 414 around the foreground object(s). The user proceeds with one or more iterations of adding an additional stroke 416 that signals the user's intention for refining the segmentation boundary 414 to the progressive cutout engine 408. In the illustrated case, the additional stroke 416 indicates that that part of an initially proposed foreground object should actually be part of the background. The progressive cutout engine 408 then refines the segmentation boundary 414 in the region of interest as the user intended without altering the segmentation boundary 414 in other parts of the image that the user did not intend, even though from a strictly color model standpoint the segmentation boundary 414 would have been adjusted in these other areas too.

Exemplary Engine

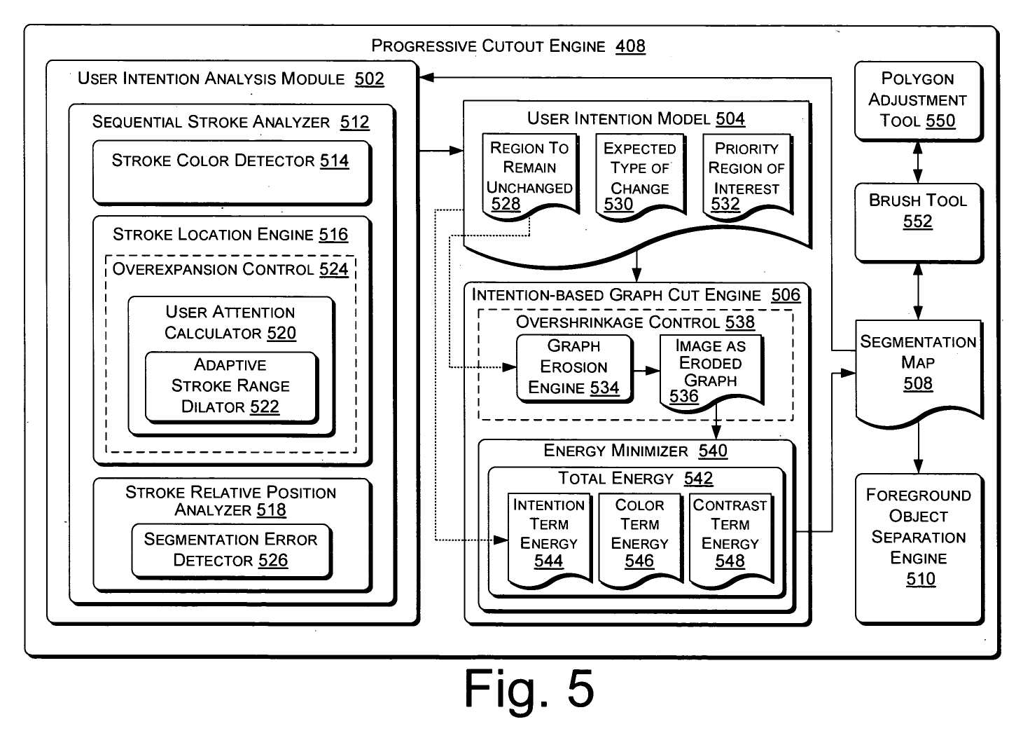

FIG. 5 shows the progressive cutout engine 408 of FIG. 4, in greater detail. The illustrated implementation in FIG. 5 is only one example configuration, for descriptive purposes. Many other arrangements of the illustrated components or even different components constituting an exemplary progressive cutout engine 408 are possible within the scope of the subject matter. Such an exemplary progressive cutout engine 408 can be executed in hardware, software, or combinations of hardware, software, firmware, etc.

The illustrated progressive cutout engine 408 includes a user intention analysis module 502 that maintains a user intention model 504, an intention-based graph cut engine 506, a segmentation map 508, and a foreground object separation engine 510. The user intention analysis module 502 includes a sequential stroke analyzer 512. The sequential stroke analyzer 512 includes a stroke color detector 514, a stroke location engine 516, and a stroke relative position analyzer 518. The stroke location engine 516 may further include a user attention calculator 520 and an adaptive stroke range dilator 522, these comprise an overexpansion control 524. The stroke relative position analyzer 518 may further include a segmentation error detector 526. The user intention model 504 may include a region to remain unchanged 528, an expected type of change 530, and a priority region of interest 532.

The intention-based graph cut engine 506 includes a graph erosion engine 534 and the image as an eroded graph 536, these comprise an overshrinkage control 538. The intention-based graph cut engine 506 also includes an energy minimizer 540 to minimize a total energy that is made up of an intention term energy 544, a color term energy 546, and a contrast term energy 548.

The progressive cutout engine 408 may also optionally include a polygon adjustment tool 550 and a brush tool 552. The illustrated configuration of the exemplary progressive cutout engine 408 is just one example for the sake of description. Other arrangements are possible within the scope of exemplary progressive cut interactive image segmentation.

Exemplary User Intention Model

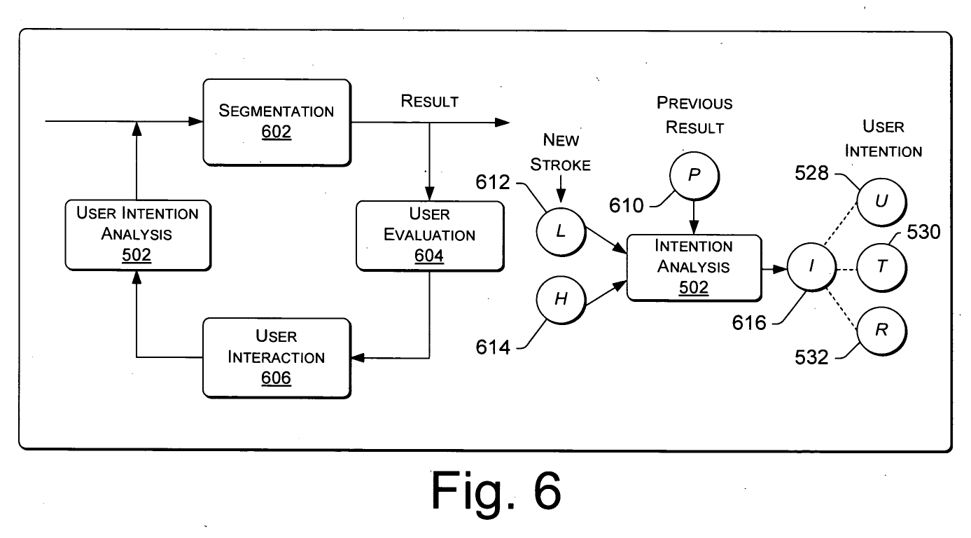

FIG. 6 shows one example implementation of the exemplary user intention model 504. In one implementation, during a first iteration of segmentation 602, the foreground is denoted as F and the background is denoted as B (F= B̅). A user evaluation 604 of the segmentation result leads to further user interaction 606 in which the user applies an additional stroke (e.g., stroke 416), the additional stroke 416 embodying the user's intention for improving the previous segmentation result. An intention analysis 502 follows the additional stroke 416 to analyze the user intention coded in the additional stroke 416. Thus, for example, the foreground area in the preceding segmentation result P 610 is denoted as Ω_{F} and the background area denoted as Ω_{B}. The label 612 of the additional stroke 416 is denoted as H (Hε{F,B}). The stroke's location 614 is denoted as L, and the label sequence of the pixels on the additional stroke is denoted as N={nᵢ}, where nᵢε{F,B} (e.g., there is N={B, F, B} when N starts from a region in the background, runs across the foreground and ends in the background).

The intention 616 of the user is denoted as I, and in one implementation it contains three parts: U is the unchanging region 528 where the user does not expect to change the segmentation label; R is the region of interest 532; and T is the kind of change 530 that the user expects (e.g. T={F→B:R} indicates that the user expects the region of interest 532 to have high priority for a change from foreground into background).

Exemplary User Intention Analysis

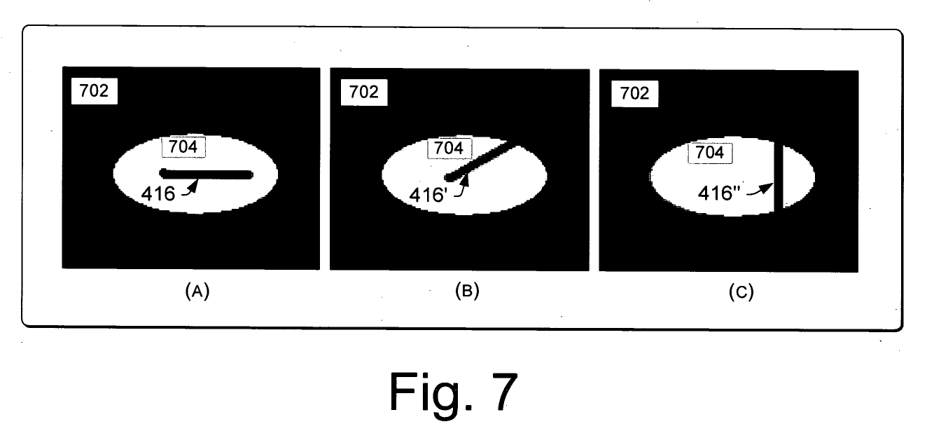

The additional strokes 416 that a user inputs during exemplary progressive cutout contain several types of user intention information. First, there are different possibilities for the manner in which the additional stroke 416 is placed by the user with respect to the previous segmentation result separating foreground and background. FIG. 7 shows various kinds of exemplary additional strokes 416, that is, different types of labels 612 and pixel sequences N for the additional stroke 416. In FIG. 7, the color blue marks the background 702 of the previous segmentation result, yellow marks the foreground 704, and purple marks the additional stroke 416 (or 416′ or 416″) having H as its label 614, that is, where H can indicate either foreground or background.

Case 1: As shown in FIG. 7(a), the additional stroke 416 is completely in the proposed foreground object and has a label 612 indicating that the object should be changed to background, i.e., when H=B, and N={F}, there is U=Ω_{B}, R= [symbol] (L)∩Ω_{F}, T={F→B:R}, where [symbol] (L) is the neighborhood of L.

Case 2: Inversely, (not shown in FIG. 7) the additional stroke 416 is completely in an object in the proposed background and has a label 612 indicating a user expectation to convert background to foreground, i.e., when H=F, and N={B}, there is U=Ω_{F} and R= [symbol] (L)∩Ω_{B}, T={B→F:R}.

Other Cases: The additional stroke 416 runs across both the background and foreground, such as N={F,B} or N={B,F} in FIG. 7(b); and N={B, F, B} in FIG. 7(c), then there are U=Ω_{H}, R= [symbol] (L)∩Ω _{H̅}, T={ H̅→H:R} where Hε{F,B}. In fact, it is easy to find out that no matter what the pixel sequence N is, there is always U=Ω_{H}, R= [symbol] (L)∩Ωd _{H̅}, T={ H̅→H:R}).

The user intention analysis module 502 receives the additional stroke 416 from a user interface 404, and analyzes the user intention of the additional stroke 416 with respect to the region of the image to remain unchanged 528, the expected type of change 530 (i.e., foreground to background or vice-versa), the user's focus or priority region of interest 532, and also the nature of the segmentation error to be corrected or improved.

The sequential stroke analyzer 512 is configured to process a sequence of additional strokes 416 as a process, instead of a conventional collection of strokes examined at a single time point. In other words, the sequential stroke analyzer 512 iteratively refines the segmentation map 508 based on user input of an additional stroke 416, and then uses the segmentation map 508 thus refined as a previous result (610 in FIG. 6) that forms the starting point for the next iteration that will be based on a subsequent additional stroke 416.

The stroke color detector 514 analyzes the color code selected for the additional stroke 416 by the user. In one implementation, a first color indicates the user's expectation of a change to foreground while a second color indicates the user's expectation of a change to background—that is, the “expected type of change” 530 of the user intention model 504. From this color code, the stroke color detector 514 can also determine the region(s) of the image that remain unchanged 528. In general, all pixels that have the same foreground or background label as the color code of the additional stroke 416 remain unchanged. Complementarily, pixels that do not have the same foreground or background label as the color code of the additional stroke 416 are candidates for label change, subject to the priority region of interest 532 determined by the stroke location engine 516.

The stroke location engine 516 detects the area of user's focus within the image based on the location of the additional stroke 416 within the image. The user may want to change a piece of foreground to background or vice-versa. An important function of the stroke location engine 516 is to determine the priority region of interest 532, thereby establishing a limit to the area in which pixel change will occur. By selecting a limited vicinity near the additional stroke 416, changes in the image are not implemented beyond the scope of the user's intention. In one implementation, the user attention calculator 520 and the adaptive stroke range dilator 522 form the aforementioned overexpansion control 524 which determines a vicinity around the additional stroke 416 that models the user's intended area in which pixel change should occur.

The stroke relative position analyzer 518 infers the change to be made to the segmentation boundary based on the relative position of the additional stroke 416 with respect to the previously obtained segmentation boundary. That is, in one implementation the segmentation error detector 526 finds an incorrectly labeled visual area near the previously iterated segmentation boundary, indicated by the additional stroke 416. For example, if the previous segmentation result erroneously omits a person's arm from the foreground in the image, then an additional stroke 302 (e.g., in FIG. 3) placed by the user on a part of the omitted arm informs the progressive cutout engine 408 that this visual object (arm) previously labeled as part of the background, should instead be added to the foreground. But often the visual area that needs relabeling is not as obvious as an human arm object in this example. To reiterate, the stroke relative position analyzer 518 figures out how to improve the segmentation boundary based on the relative position of the additional stroke 416, which points up the visual area near the segmentation boundary to change.

Exemplary Graph Cut Engine

In one implementation, the progressive cutout engine 408 models segmentation in a graph cut framework, and incorporates the user intention into the graph cut model. Suppose that the image is a graph G={V, E}, where V is the set of all nodes and E is the set of all arcs connecting adjacent nodes. Usually, the nodes are pixels on the image and the arcs are adjacency relationships with four or eight connections between neighboring pixels. The labeling problem (foreground/background segmentation or “object cutout”) is to assign a unique label xᵢ for each node iεV, i.e., xᵢε {foreground (=1), background (=0)}. The labeling problem can be described as an optimization problem which minimizes the energy defined as follows by a min-cut/max-flow algorithm, as in Equation (1):

$$E ( X ) = λ {\sum }_{i ∈ V} {E}_{1} ( {x}_{i} ) + ( 1 - λ ) {\sum }_{( i , j ) ∈ E} {E}_{2} ( {x}_{i} , {x}_{j} ) \qquad ( 1 )$$

where Eₗ(xᵢ) is the data energy, encoding the cost when the label of node i is xᵢ, and E₂(xᵢ, xⱼ) is the smoothness energy, denoting the cost when the labels of adjacent nodes i and j are xᵢ and xⱼ respectively.

To model exemplary progressive cutout in the above energy minimization framework, I={U, R, T} as shown in FIG. 6, with the additional stroke {H,L} 416 and the previous segmentation result P610. From the region to remain unchanged U528, the graph erosion engine 534 can erode the graph on the whole image G={V,E} into a smaller graph 536, i.e., G′={V′, E′}, for faster computation. From U, R, and T, the energy minimizer 540 defines the energy function as in Equation (2):

$$E ( X ) = α {\sum }_{i ∈ {V}^{′}} {E}_{color} ( {x}_{i} ) + β {\sum }_{i ∈ {V}^{′}} {E}_{user} ( {x}_{i} ) + ( 1 - α - β ) {\sum }_{( 1 , j ) ∈ {E}^{′}} {E}_{contrast} ( {x}_{i} , {x}_{j} ) \qquad ( 2 )$$

where E_{color} (xᵢ) is the color term energy 546, encoding the cost in color likelihood, Eᵤₛₑᵣ (xᵢ) is the user intention term 544, encoding the cost in deviating from the user's expectation I={U, T, R}, and E_{contrast}(xᵢ, xⱼ) is the contrast term 548 (or smoothness term), which constrains neighboring pixels with low contrast to select the same labels.

Exemplary Eroded Graph for Progressive Cut

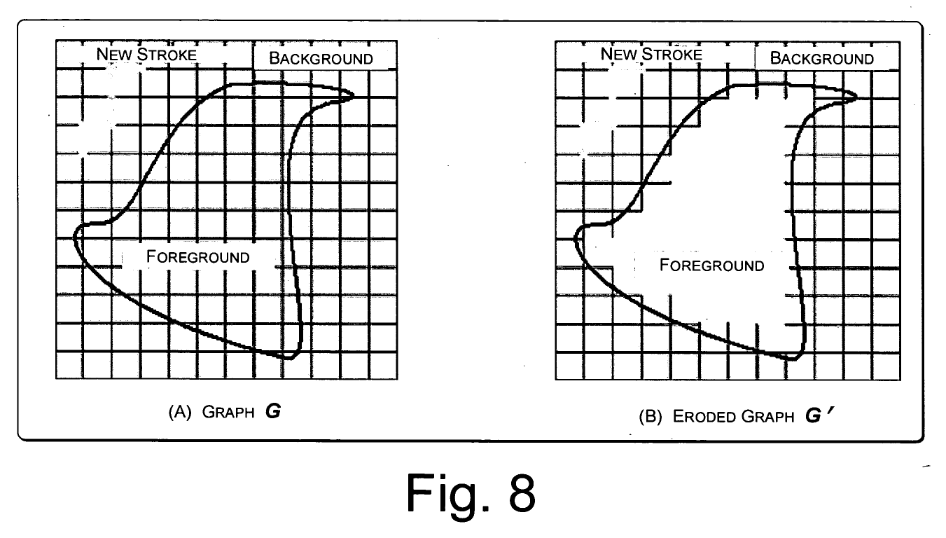

In one implementation, the graph erosion engine 534 denotes the segmentation result as P={pᵢ}, where pᵢ is the current label of pixel i, with the value 0/1 corresponding to background/foreground, respectively. The graph erosion engine 534 further denotes the locations of the additional stroke 416 specified by the user as a set of nodes L={i₁, i₂, . . . iₜ}⊂V, H, U, T and R. Equating H=F as shown in FIG. 8(a) yields U=Ω_{F}, R= [symbol] (L)∩Ω_{B}, T={B→F: R}, according to the exemplary user intention model 504. Then, as shown in FIG. 8(b), the graph erosion engine 534 first constructs a new graph G′={V′, E′} by eroding U (except the pixels neighboring the boundary) out of the graph of the whole image G={V, E}. Such erosion also accords with the user's intention, since nodes being eroded safely lie in the unchanging region U 528. Hence, the energies and the corresponding energy optimization described in the following sections are defined on the eroded graph G in FIG. 8(b).

Color Term Energy

In one implementation, the progressive cutout engine 408 defines the color term E_{color}(xᵢ) in Equation (2) as follows. Assume the foreground stroke nodes are denoted as V_{F}={i_{F1}, . . . i_{FM}} E V and the background stroke nodes are denoted as V_{B}={i_{B1}, . . . i_{BM}}εV. The color distribution of foreground can be described as a Gaussian Mixture Model (GMM) as in Equation (3), i.e.,

$${p}_{F} ( {C}_{i} ) = {\sum }_{k = 1}^{K} {ω}_{k} {p}_{Fk} ( {μ}_{Fk} , {\sum }_{Fk} , {C}_{i} ) \qquad ( 3 )$$

where p_{Fk} is the k-th Gaussian component with the mean and covariance matrix as {μ_{Fk}, Σ_{Fk}}, and ωₖ is the weight. The background color distribution p_{B}(Cᵢ) can be described in a similar way.

For a given node i with color Cᵢ, the color term is defined as:

If iεV_{F}∩V′, there is E(xᵢ=1)=0,E(xᵢ=0)=+∞;

If iεV_{B}∩V′, there is E(xᵢ=1)=+∞,E(xᵢ=0)=0;

### Otherwise, as in Equation set (4):

$$E ( {x}_{i} = 1 ) = \frac{log ( {p}_{F} ( {C}_{i} ) )}{log ( {p}_{F} ( {C}_{i} ) ) + log ( {p}_{B} ( {C}_{i} ) )} , \\ E ( {x}_{i} = 0 ) = \frac{log ( {p}_{B} ( {C}_{i} ) )}{log ( {p}_{F} ( {C}_{i} ) ) + log ( {p}_{B} ( {C}_{i} ) )} . \qquad ( 4 )$$

Contrast Term Energy

The energy minimizer 540 can define the contrast term E_{contrast}(xᵢ, xⱼ) as a function of the color contrast between two nodes i and j, as in Equation (5):

E_{contrast}(xᵢ,xⱼ)=|xᵢ−xⱼ|·g(Cᵢⱼ) (5)

where

$$g ( ξ ) = \frac{1}{ξ + 1} ,$$

and Cᵢⱼ=∥Cᵢ−Cⱼ∥² is the L₂-norm of the RGB color difference of two pixels i and j. The term |xᵢ−xⱼ| allows the intention-based graph cut engine 506 to capture the contrast information only along the segmentation border. Actually E_{contrast} is a penalty term when adjacent nodes are assigned with opposite labels. The more similar the two nodes are in color, the larger E_{contrast} is, and thus the less likely the two nodes are assigned with opposite labels.

User Intention Term Energy

The user intention term Eᵤₛₑᵣ is a nontrivial term of the total energy 542, which encodes the cost of deviating from the user's expectation. Since U=Ω_{H}, that is, the unchanging region 528 contains all the pixels with the same label as the additional stroke 416, the corresponding user intention term 544 is set as in Equation (6):

$$\{ \begin{matrix}{E}_{user} ( {x}_{i} = \overline{H} ) = + ∞ \\ {E}_{user} ( {x}_{i} = H ) = 0\end{matrix} , ∀ i ∈ {Ω}_{H} ⋂ {V}^{′} \qquad ( 6 )$$

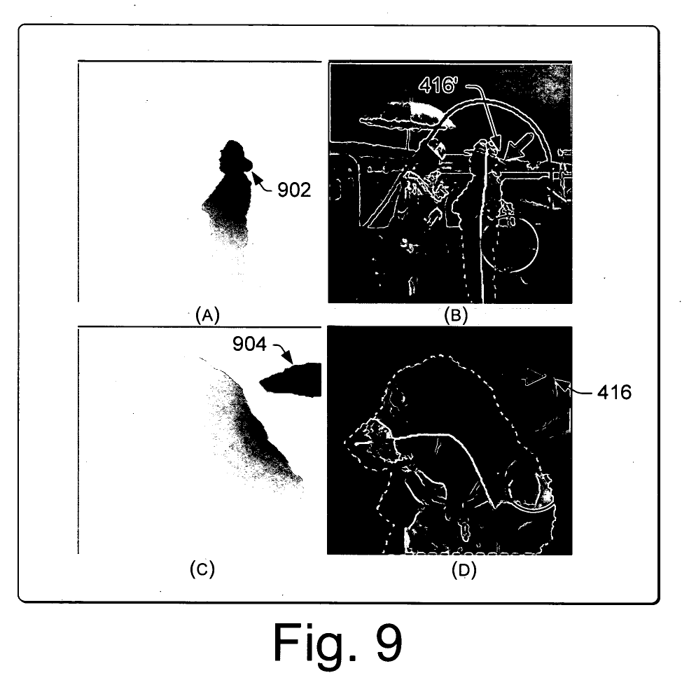

Since R= [symbol] (L)∩Ω _{H̅} and T={ H̅→H:R}, for pixels with a label opposite to that of the additional stroke 416, the user attention calculator 520 infers that the user's attention is concentrated in the neighborhood of the stroke, and the user's attention decreases as the distance to the stroke becomes larger. Therefore, the user intention term is set as in Equation (7):

$${E}_{user} ( {x}_{i} ) = \vert {x}_{i} - {p}_{i} \vert \frac{{min}_{1 \leq k \leq t} ‖ i - {i}_{k} ‖}{r} , ∀ i ∈ {Ω}_{\overline{H}} ⋂ {V}^{′} \qquad ( 7 )$$

where ∥i−iₖ∥ is the distance between the node i and iₖ, xᵢ−pᵢ| is an indicator of label change, r is a parameter that the adaptive stroke range dilator 522 applies to control the range of user's attention: a larger r implies larger range. The implication of Equation (7) is that there should be an extra cost to change the label of a pixel, and the cost is higher when the pixel is farther from the focus of the user's attention as represented by the additional stroke 416. An example depiction of the magnitude of the energy of the user's attention is shown in FIG. 9(a) and FIG. 9(c), where higher intensity (902 and 904) indicates larger energy. FIGS. 9(b) and 9(d) are the segmentation results using the exemplary progressive cutout engine 408 with the additional strokes 416 and 416′ pointed out by the green arrows.

Detailed Operation of the Exemplary Progressive Cutout Engine

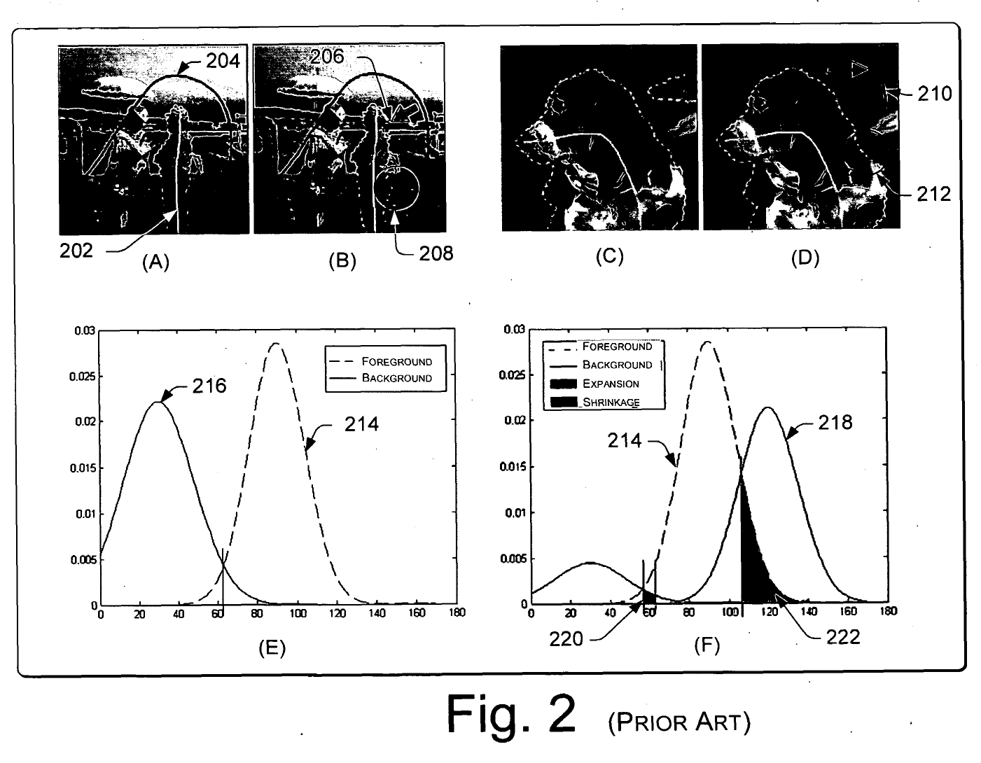

The exemplary progressive cutout engine 408 includes an overexpansion control 524 and an overshrinkage control 538 with respect to pixel labels (either “foreground” or “background”) in an image. These prevent the segmentation boundary between foreground and background from misbehaving at image locations not intended by the user, when the user inputs an additional stroke 416. For example, assume that the user expects the label of the pixels in the area A of an image to change into label H 612. If there is another area D outside of A, where the pixels change their labels into label H 612 when their correct label should be H̅, this effect is referred to as the overexpansion of label H 612. If there is another area E outside of A where pixels change their labels into H̅ when their correct label should be H, this is referred to as the overshrinkage of label H 612. For example, as shown in FIG. 2(b), the user adds a blue stroke 206 (i.e., color indicating an intention to change to background) behind the neck of the man, indicating the user would like to expand the background in that area. However, the pixels behind the trousers 208 of the depicted man change their labels from background to foreground, i.e., overshrinkage of the background occurs after the additional stroke 206 is input. Similarly, in FIG. 2(d), there is an overexpansion 212 of the background in the dog's back (as the red circle points out). Overexpansion and overshrinkage are two kinds of erroneous label change that deviate from the user's expectation and thereby cause unsatisfactory results.

Compared with conventional stroke-based graph-cut techniques, the exemplary progressive cutout engine 408 can effectively prevent the overshrinkage and overexpansion in low-interest areas, as shown in FIG. 9(b) and FIG. 9(d). The graph erosion engine 534 prevents the overshrinkage (e.g., FIG. 9(b) versus FIG. 2(b)) by eroding the region to remain unchanged U 528 out of the graph of the whole image (see FIG. 8) and setting the infinity penalty as in Equation (6), which aims to guarantee that there is no label change in areas that have a label the same as the additional stroke 416. The compression of overexpansion (i.e., FIG. 9(d) versus FIG. 2(d)) is achieved by adding the user intention term 544 as in Equation (7) in the energy function, which assigns larger penalty to those areas farther away from the user's high attention area. In this manner, the exemplary progressive cutout engine 408 changes the previous segmentation results according to the user's expectations, and thereby provides the user more control in fewer strokes, with no fluctuation effect.

Another notable advantage of the exemplary progressive cutout engine 408 is that it provides faster visual feedback to the user. Since the eroded graph 536 is generally much smaller than a graph of the whole image, the computational cost in the optimization process is greatly reduced.

Exemplary User Attention Range Parameter Setting

The adaptive stroke range dilator 522 sets the parameter r, which is used to infer the range of the user's attention. In one implementation, the adaptive stroke range dilator 522 automatically sets the parameter r to endow the progressive cutout engine 408 with adaptability. The operation can be intuitively described as follows. Given a previous segmentation boundary proposal, and an additional stroke 416 specified by the user, if the additional stroke 416 is near to the segmentation boundary, then it is probable that the user's attention is focused on a small region around the stroke, and thus a small value for parameter r should be selected. Otherwise, the user's current attention range is likely to be relatively large, and thus a large value of r is automatically selected.

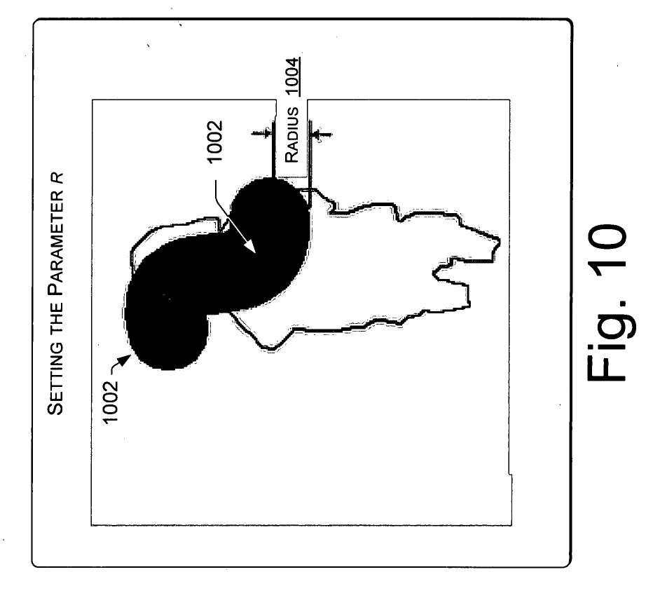

FIG. 10 shows an exemplary instance of setting the parameter r. In one implementation, the adaptive stroke range dilator 522 balloons the additional stroke 416 with an increasing radius until the dilated stroke 1002 covers approximately 5% of the total length of the border. The parameter r is set to be the radius 1004 when the stroke 416 stops dilating. Such a parameter r aims to measure the user's current attention range, and makes the progressive cutout engine 408 adaptive to different images, different stages of user interaction, and different users.

Variations

The exemplary progressive cutout engine 408 uses additional strokes 416 to remove errors in large areas of a segmentation result quickly, in a few steps with a few simple additional strokes. After the erroneous area reduces to a very low level, the optional polygon adjustment tool 550 and brush tool 552 may be used for local refinement.

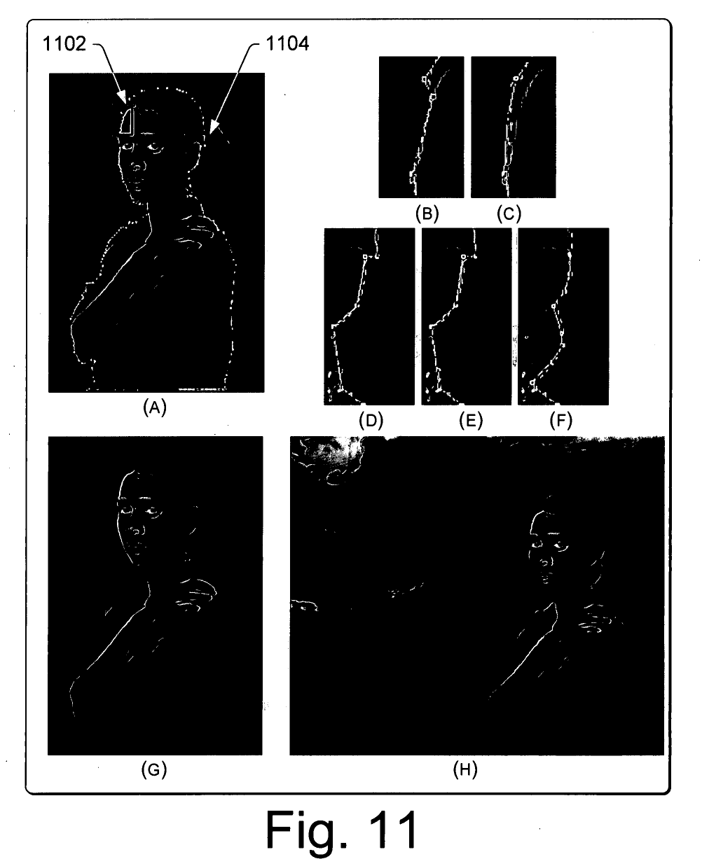

FIG. 11 shows fine scale refinement of the segmentation boundary using such tools. FIG. 11(a) is an image called “Indian girl” with the segmentation result that is obtained using exemplary additional strokes. The red rectangles 1102 and 1104 show the region to be adjusted by the polygon adjustment tool 550 and the brush tool 552. FIGS. 11(b) and 11(c) show the region 1102 before and after polygon adjustment. FIGS. 11(d), 11(e), and 11(f) show the region 1104 before, during and after the brush adjustment. FIG. 11(g) is the final object cutout result; and FIG. 11(h) is the composition result using the cutout result of FIG. 11(g) with a new background.

In one implementation, for the sake of computational speed, the progressive cutout engine 408 may conduct a two-layer graph-cut. The progressive cutout engine 408 first conducts an over-segmentation by watershed and builds the graph based on the segments for a coarse object cutout. Then, the progressive cutout engine 408 implements a pixel-level graph-cut on the near-boundary area in the coarse result, for a finer object cutout.

Exemplary Methods

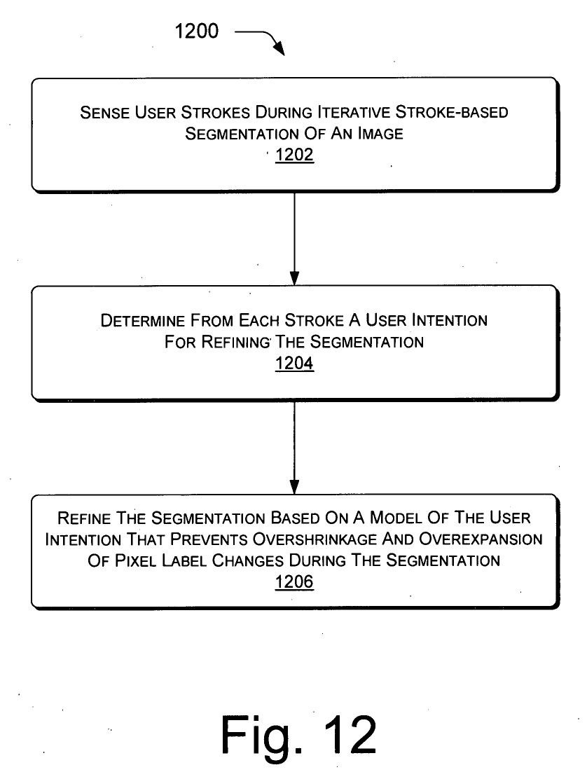

FIG. 12 shows an exemplary method 1200 of performing exemplary progressive cutout. In the flow diagram, the operations are summarized in individual blocks. The exemplary method 1200 may be performed by hardware, software, or combinations of hardware, software, firmware, etc., for example, by components of the exemplary progressive cutout engine 408.

At block 1202, successive user strokes are sensed during iterative segmentation of an image. Each additional user stroke is treated as part of a progressive iterative process rather than as a collection of user inputs that affect only the color model of the image.

At block 1204, a user intention for refining the segmentation is determined from each stroke. In one implementation, this includes determining a color of the stroke to indicate the kind of pixel label change the user expects, determining a location of the stroke to indicate the user's region of interest, and determining a position of the stroke relative to a previous segmentation boundary to indicate the segmentation error that the user intends to refine.

At block 1206, the previously iterated segmentation result is refined based on a model of the user intention that prevents overshrinkage and overexpansion of pixel label changes during the segmentation. For example, by assigning a radius around the location of the stroke as the user's region of interest, changes outside the region of interest can be limited or avoided. A segmentation map is iteratively refined by minimizing an energy for each pixel, the energy being constituted of a color term, a contrast, term and a user intention term. By assigning a cost penalty to pixel changes that increases in relation to their distance from the latest user stroke, unwanted fluctuations in foreground and background are avoided. The exemplary method 1200 provides the user a more controllable result with fewer strokes and faster visual feedback

Results

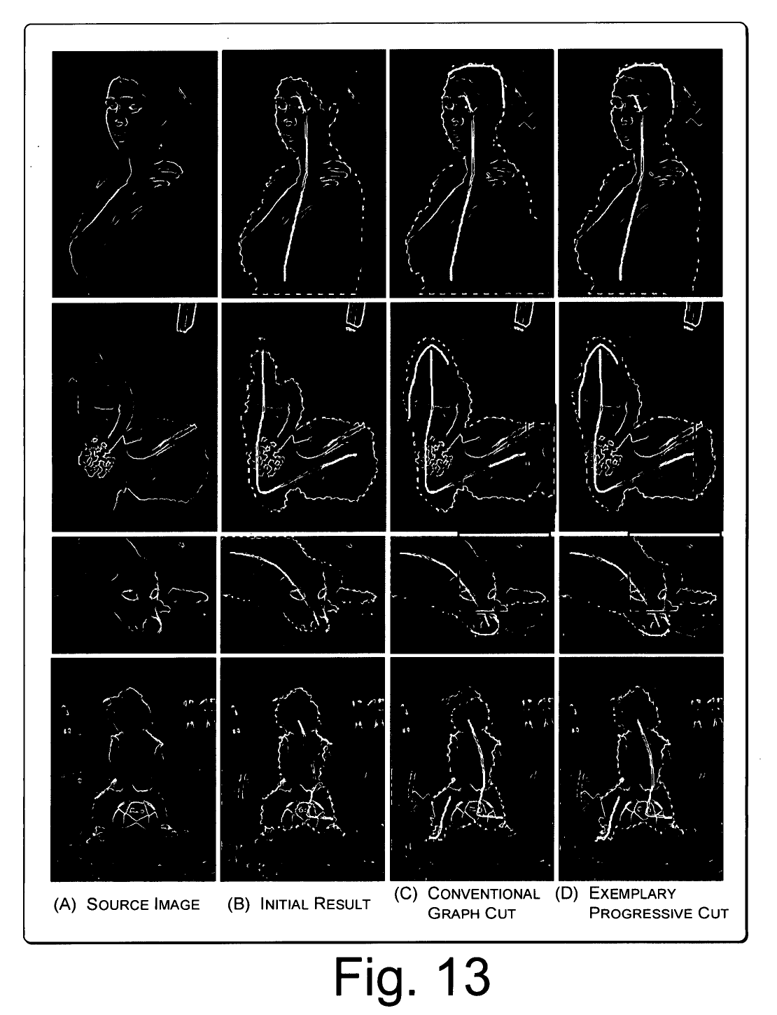

FIG. 13 shows a comparison of the accuracy of a conventional graph cut technique after one additional stroke with the accuracy of the exemplary progressive cutout engine 408 and method 1200 after the additional stroke. Different image sources are shown in different rows. From top to bottom, the images are “Indian girl”, “bride”, “sleepy dog,” and “little girl”. Column (a) shows the source images; and column (b) shows the initial segmentation results. The initial two strokes that obtained the initial segmentation results in column (b) are marked yellow for foreground and blue for background. Column (c) shows conventional graph cut results after an additional stroke is input by the user (indicated by green arrows). Inaccurate results of conventional graph cut are shown in the (red) rectangles of column (c). Column (d) shows the exemplary progressive cutout engine 408 and method 1200 results, obtained from the same additional stroke as used for the conventional graph cut results in column (c). The accurate results achieved by the exemplary progressive cutout engine 408 and method 1200 are shown in the (red) rectangles of column (d).

### CONCLUSION

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method, comprising:
sensing user strokes during iterative segmentation of an image;
determining from each stroke a user intention for refining the segmentation; and
refining the segmentation based on a model of the user intention that prevents overshrinkage and overexpansion of pixel label changes during the segmentation.

2. The method as recited in claim 1, wherein each successive stroke refines a segmentation boundary of the image by changing pixel labels to either foreground or background.

3. The method as recited in claim 1, further comprising building the model of the user intention by modeling for each stroke a kind of pixel label change that the user expects, a region of the user's interest in the image, and a segmentation error that the user intends to refine.

4. The method as recited in claim 3, wherein building the model further includes modeling for each stroke a region of the image to remain unchanged, the region to remain unchanged comprising pixels of the image that maintain a constant pixel label during an iteration of the segmentation.

5. The method as recited in claim 3, further comprising:
determining a color of the stroke to indicate the kind of pixel label change the user expects;
determining a location of the stroke to indicate the user's region of interest; and
determining a relative position of the stroke with respect to a previous segmentation boundary to indicate the segmentation error that the user intends to refine.

6. The method as recited in claim 5, wherein determining a location of the stroke to indicate the user's region of interest further includes selecting an area of the image defined by a radius around the stroke as the user's region of interest, the magnitude of the radius varying in relation to the distance between the stroke and the previous segmentation result.

7. The method as recited in claim 5, wherein refining the segmentation includes refining only in the user's region of interest.

8. The method as recited in claim 1, further comprising modeling the image as a graph, including eroding a foreground part of the graph to prevent the overshrinkage of a background part of the graph during segmentation.

9. The method as recited in claim 8, wherein the eroding results in a faster computation of the segmentation.

10. The method as recited in claim 1, wherein refining the segmentation further includes describing segmentation labeling in terms of an energy cost and associating the user intention with minimizing the energy cost.

11. The method as recited in claim 10, further comprising estimating an energy cost of deviating from the user intention.

12. The method as recited in claim 11, further comprising assigning a penalty to changing labels of pixels, the magnitude of the penalty varying in relation to a distance of the pixels from the user's region of interest.

13. The method as recited in claim 1, wherein refining the segmentation includes minimizing an energy for each pixel to obtain a segmentation map, wherein the energy includes a color term, a contrast term, and a user intention term.

14. A system, comprising:
a graph cut engine; and
an intention analysis module for incorporating user intentions into a graph cut framework.

15. The system, as recited in claim 14, further comprising:
a sequential stroke analyzer to sense user strokes during iterative segmentation of an image, wherein the sequential stroke analyzer determines from each stroke a user intention for refining the segmentation;
a stroke color detector to determine a color of the stroke for indicating a kind of pixel label change the user expects;
a stroke location engine to determine a location of the stroke to indicate the user's region of interest; and
a stroke relative position analyzer to determining a relative position of the stroke with respect to a previous segmentation boundary for indicating the segmentation error that the user intends to refine.

16. The system, as recited in claim 14, further comprising a user intention model that prevents overshrinkage and overexpansion of the segmentation.

17. The system as recited in claim 16, further comprising an overexpansion control wherein a user attention calculator determines the user's region of interest associated with each stroke for limiting overexpansion of pixel label changes during the segmentation.

18. The system as recited in claim 16, further comprising an overshrinkage control wherein a graph erosion engine renders the foreground of the image as an eroded graph for limiting overshrinkage of pixel label changes during the segmentation.

19. The system as recited in claim 14, further comprising:
an energy minimizer for describing segmentation labeling in terms of an energy cost that includes a color term energy, a contrast term energy, and an intention term energy;
wherein the intention term energy represents a cost of deviating from the user's intention with respect to improving the segmentation.

20. A system, comprising:
means for performing stroke-based graph cutting;
means for modeling a user intent for each stroke; and
means for segmenting an image based on the user intent to prevent overexpansion and overshrinkage of pixel label changes during segmentation.
